(19) United States
(12) Patent Application Publication
(10) Pub. No.: US 2019/0162304 A1
(43) Pub. Date: May 30, 2019

(54) CONTROL DEVICE OF VEHICLE

(71) Applicant: TOYOTA JIDOSHA KABUSHIKI KAISHA, Toyota-shi (JP)

(72) Inventor: Yuichi KIDA, Toyota-shi (JP)

(73) Assignee: TOYOTA JIDOSHA KABUSHIKI KAISHA, Toyota-shi (JP)

(21) Appl. No.: 16/199,786

(22) Filed: Nov. 26, 2018

(30) Foreign Application Priority Data
Nov. 24, 2017 (JP) 2017-226318

(51) Int. Cl. F16H 63/34

(52) U.S. Cl. CPC F16H 63/3425; B60R 25/007; F16H 63/3483

(57) ABSTRACT

A control device of a vehicle comprising: a power transmission device; a rotating member; a parking lock mechanism including a parking gear and a parking pawl; and an operating member, the parking lock mechanism further including a cam, a parking rod, and a spring mechanism, configured in that: the control device includes a vehicle speed control portion to control a vehicle speed such that when the operating member is operated to a parking operating position and the vehicle speed is in a predetermined vehicle speed range determined in advance of a vehicle speed at which a load to be applied to the parking pawl due to collision with the parking gear increases while running of the vehicle, the vehicle speed comes out of the predetermined vehicle speed range.

This application claims priority from Japanese Patent Application No. 2017-226318 filed on Nov. 24, 2017, the disclosure of which is herein incorporated by reference in its entirety.

### FIELD OF THE ART

The present invention relates to a control device of a vehicle, including an operating member to be operated by a driver to any of a plurality of operating positions, and a parking lock mechanism mechanically connected to the operating member.

### BACKGROUND ART

A control device of a vehicle is well-known which includes a parking lock mechanism including a parking gear provided so as to rotate integrally with a rotating member that rotates together with drive wheels; a parking pawl configured to mesh with the parking gear; a tapered cam configured to mesh the parking pawl with the parking gear by being moved to a parking pawl side; a parking rod supporting the cam at one end portion on the parking pawl side, and a spring mechanism configured to bias the cam to the parking pawl side along with movement of the parking rod to the one end portion side; and being configured to establish a parking state of a power transmission device in which the rotating member is fixed in a non-rotatable manner by meshing the parking pawl with the parking gear, and an operating member to be operated by a driver to any of a plurality of operating positions including a parking operating position to select the parking state of the power transmission device. For example, a vehicle described in Patent Document 1 is this type of vehicle. This Patent Document 1 discloses that a parking lock mechanism is electrically actuated by an actuator in response to a selecting operation performed by a driver on an operating member, and that in a case where a vehicle speed is equal to or larger than a predetermined vehicle speed when the operating member is operated to the parking operating position by a driver, the parking lock mechanism is actuated so as to increase a braking force of a wheel brake and form a parking position of the power transmission device after the vehicle speed is decreased to the predetermined vehicle speed or lower by the braking force of the wheel brake.

### PRIOR ART DOCUMENT

### Patent Document

### [PATENT DOCUMENT 1] Japan Patent Publication No. 2010-214976

### SUMMARY OF THE INVENTION

### Technical Problem

A parking lock mechanism configured so that a parking rod is mechanically connected to an operating member via a connecting member at the other end portion opposite to a parking pawl side, and along with an operation of the operating member to the parking operating position, the parking rod is moved toward the one end portion side, is also well-known. In this parking lock mechanism mechanically connected to the operating member, when the operating member is operated to the parking operating position by a driver while running of the vehicle, the parking lock mechanism is actuated so as to establish a parking state of the power transmission device regardless of a vehicle speed. At this time, when the vehicle speed is higher than an engage vehicle speed under which the parking pawl can be meshed with the parking gear, the parking pawl is repelled by the parking gear and repeatedly attempts to mesh with the parking gear by the spring mechanism. The parking pawl is subjected to a load caused by collision with the parking gear, and it is desired to reduce the burden on the parking lock mechanism caused by such a load. That is, it is desired to suppress deterioration in durability of the parking lock mechanism due to such a load.

The present invention has been made in consideration of the above circumstances as the background, and an object thereof is to provide a control device of a vehicle, which reduces the burden on the parking lock mechanism when the operating member is operated to the parking operating position while running.

### Solution to Problem

A first aspect of the present invention provides a control device of a vehicle comprising: (a) a power transmission device provided in a power transmission path between a power source and a drive wheel; a rotating member constituting a part of the power transmission device and rotating together with the drive wheel; a parking lock mechanism including a parking gear provided so as to rotate integrally with the rotating member and a parking pawl configured to mesh with the parking gear, and being configured to form a parking state of the power transmission device in which the rotating member is fixed in an non-rotatable manner by meshing the parking pawl with the parking gear; and an operating member to be operated by a driver to any of a plurality of operating positions including a parking operating position to select a parking position of the power transmission device, the parking lock mechanism further including a cam tapered so as to become smaller in diameter toward the parking pawl side and configured to mesh the parking pawl with the parking gear by being moved to the parking pawl side, a parking rod supporting the cam at one end portion on the parking pawl side and mechanically connected to the operating member via a connecting member at the other end portion opposite to the parking pawl side, and configured to be moved toward the one end portion side along with an operation of the operating member to the parking operating position, and a spring mechanism configured to bias the cam to the parking pawl side along with movement of the parking rod toward the one end portion side, configured in that: the control device includes (b) a vehicle speed control portion to control a vehicle speed such that when the operating member is operated to the parking operating position and the vehicle speed is in a predetermined vehicle speed range determined in advance of a vehicle speed at which a load to be applied to the parking pawl due to collision with the parking gear increases while running of the vehicle, the vehicle speed comes out of the predetermined vehicle speed range.

A second aspect of the present invention provides the control device of a vehicle recited in the first aspect of the invention, wherein the predetermined vehicle speed range is a vehicle speed range equal to or larger than an upper limit vehicle speed in a low vehicle speed range in which the load becomes relatively small due to a low rotation speed of the parking gear, and equal to or lower than a lower limit vehicle speed in a high vehicle speed range in which, due to a high rotation speed of the parking gear, meshing of the parking pawl with the parking gear becomes relatively shallow and the load becomes relatively small.

A third aspect of the present invention provides the control device of a vehicle recited in the first or second aspect of the invention, wherein the vehicle speed control portion controls the vehicle speed so as to make the vehicle speed come out of the predetermined vehicle speed range by performing a control to promote deceleration of the vehicle.

A fourth aspect of the present invention provides the control device of a vehicle recited in the third aspect of the invention, wherein the control to promote deceleration of the vehicle is a control to apply a brake torque to the vehicle without depending on an operation by the driver.

### Advantageous Effects of Invention

According to the control device of a vehicle recited in the first aspect of the invention, when the operating member is operated to the parking operating position and the vehicle speed is in the predetermined vehicle speed range at which the load to be applied to the parking pawl due to collision with the parking gear increases while running of the vehicle, the vehicle speed is controlled so as to come out of the predetermined vehicle speed range, so that the period of time during which the vehicle speed stays in the vehicle speed range where the load to be applied to the parking pawl is increased is shortened. Accordingly, the number of collisions of the parking pawl with the parking gear which apply a significant load to the parking pawl is reduced. Therefore, when the operating member is operated to the parking operating position while running of the vehicle, the burden on the parking lock mechanism can be reduced.

According to the control device of a vehicle recited in the second aspect of the invention, the predetermined vehicle speed range is a vehicle speed range equal to or larger than the upper limit vehicle speed in the low vehicle speed range in which, due to a low rotation speed of the parking gear, the load to be applied to the parking pawl becomes relatively small, and equal to or lower than the lower limit vehicle speed in the high vehicle speed range in which, due to a high rotation speed of the parking gear, meshing of the parking pawl with the parking gear becomes relatively shallow and the load becomes relatively small, so that a period of time during which the vehicle speed stays in the vehicle speed range where the load is increased is shortened by controlling the vehicle speed so as to make the vehicle speed come out of the predetermined vehicle speed range.

According to the control device of a vehicle recited in the third aspect of the invention, the vehicle speed is controlled so as to come out of the predetermined vehicle speed range by performing the control to promote deceleration of the vehicle, so that a period of time during which the vehicle speed stays in the vehicle speed range in which the burden on the parking pawl increases is appropriately shortened by quick deceleration of the vehicle.

According to the control device of a vehicle recited in the fourth aspect of the invention, the control to promote deceleration of the vehicle is a control to apply a brake torque to the vehicle without depending on a driver's operation, so that the vehicle is quickly decelerated by the control to promote deceleration of the vehicle.

### BRIEF DESCRIPTION OF DRAWINGS

FIG. 1 is a view describing a general configuration of a vehicle to which the present invention is applied, and describing essential portions of control functions and control systems for various controls in the vehicle.

FIG. 2 is a view showing an example of a parking lock mechanism.

FIG. 3 shows a flowchart describing an essential portion of a control operation of an electronic control device, that is, a control operation to reduce the burden on the parking lock mechanism when a shift lever is operated to a parking operating position while running of the vehicle.

FIG. 4 is a diagram showing an example of a time chart when the control operation shown in the flowchart of FIG. 3 is executed.

### DESCRIPTION OF THE EMBODIMENT

In an embodiment of the present invention, the power transmission device includes an automatic transmission that transmits power of the power source to the drive wheels. The automatic transmission can be, for example, a publicly-known planetary gear type stepped transmission, a publicly-known synchromesh parallel biaxial stepped transmission, a publicly-known DCT (Dual Clutch Transmission) that is type of a synchromesh parallel biaxial stepped transmission and includes two systems of input, a publicly-known belt-driven or toroidal continuously variable transmission, or a publicly-known electrically controlled continuously variable transmission, etc. When the power transmission device includes an automatic transmission such as the above-described planetary gear type stepped transmission or the above-described belt-driven continuously variable transmission, the power transmission device includes a fluid type transmission device such as a torque converter and a fluid coupling.

The rotating member provided so as to rotate integrally with the parking gear can be, for example, an output shaft or an output gear as an output rotating member of the automatic transmission, or a gear constituting a gear pair by meshing with the output gear.

The brake torque can be, for example, a brake torque generated by a power source brake, a brake torque generated by a wheel brake, a brake torque generated by a parking brake.

The power source can be, for example, an engine such as a gasoline engine or diesel engine that generates power by combusting a fuel, and/or a motor, etc. When the power source is the engine, an engine brake can be used as the power source brake. When the power source is the motor, a regenerative brake can be used as the power source brake.

Hereinafter, an embodiment of the present invention is described in detail with reference to the drawings.

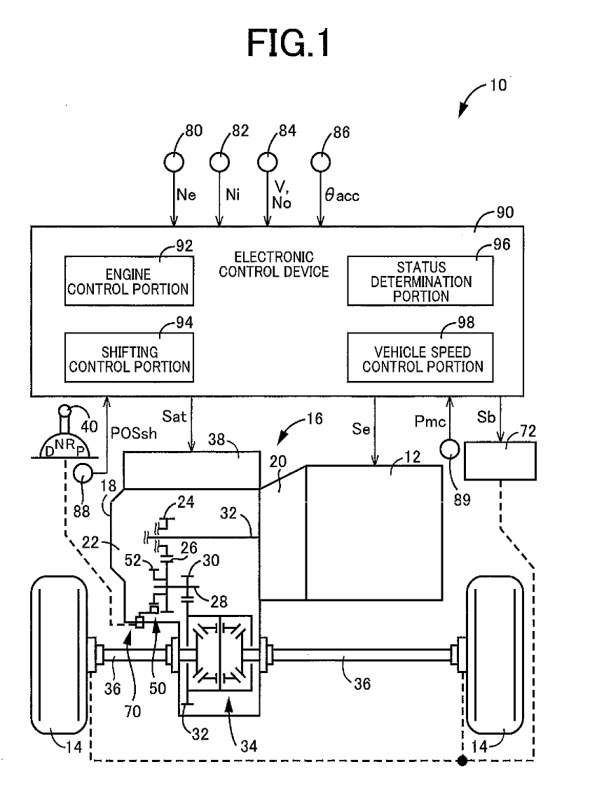

FIG. 1 is a view describing a general configuration of a vehicle 10 to which the present invention is applied, and describing essential portions of control functions and control systems for various controls in the vehicle 10. In FIG. 1, the vehicle 10 includes an engine 12, drive wheels 14, and a power transmission device 16 provided in a power transmission path between the engine 12 and the drive wheels 14. The power transmission device 16 includes, inside a case 18 as a non-rotating member to be attached to a vehicle body, a torque converter 20, an automatic transmission 22, a driven gear 26 to mesh with an output gear 24 as an output rotating member of the automatic transmission 22, a counter shaft 28 fixing the driven gear 26 in a relatively non-rotatable manner, a drive pinion 30 fixed to the counter shaft 28 in a relatively non-rotatable manner, and a differential gear 34 to mesh with the drive pinion 30 via a differential ring gear 32. Further, the power transmission device 16 includes a pair of drive shafts 36 connected to the differential gear 34. The drive pinion 30 has a smaller diameter than the driven gear 26. In the power transmission device 16, power output from the engine 12 is transmitted to the drive wheels 14 through the torque converter 20, the automatic transmission 22, the driven gear 26, the drive pinion 30, the differential gear 34, and the drive shaft 36, etc., in order. The power is used in the similar meaning as a torque and a force unless distinguished from each other.

The engine 12 is a power source of the vehicle 10. An engine torque Te of the engine 12 is controlled according to control of an operating state such as an intake air amount, a fuel supply amount, and/or an ignition timing, etc., by an electronic control device 90 described later.

The torque converter 20 is disposed in the power transmission path between the engine 12 and the automatic transmission 22, and is a fluid type transmission device including a pump wheel to which the engine 12 is connected in a power transmittable manner, and a turbine wheel connected to the automatic transmission 22 in a power transmittable manner.

The automatic transmission 22 is an automatic transmission constituting a part of the power transmission path between the engine 12 and the drive wheels 14. The automatic transmission 22 is a publicly-known planetary gear type stepped transmission including, for example, a plurality of planetary gear sets, and a plurality of engagement devices. The engagement devices are, for example, hydraulically-operated frictional engagement devices. As engagement pressures of the engagement devices, regulated hydraulic pressures are respectively output from a hydraulic control circuit 38 of the vehicle 10. In the automatic transmission 22, a gear position to be formed is switched, that is, one of a plurality of gear positions are selectively established by controlling actuation states of the engagement devices according to an accelerator operation performed by a driver and a vehicle speed V, etc. by an electronic control device 90 described later. The actuation state of the engagement device is a released state or an engaged state.

The vehicle 10 further includes a shift lever 40 as an operating member to be operated by a driver to any of a plurality of operating positions POSsh. The operating positions POSsh of the shift lever 40 include, for example, P, R, N, and D operating positions.

The P operating position is a parking operating position to select a parking state of the power transmission device 16. The parking state of the power transmission device 16 is a shift position among a plurality of shift positions of the power transmission device 16 and at which the power transmission device 16 is put into a neutral state and the driven gear 26 is fixed in a non-rotatable manner. The neutral state of the power transmission device 16 is a neutral state of the automatic transmission 22 in which no gear position is formed, and is a state where power transmission in the power transmission device 16 is blocked. The neutral state of the automatic transmission 22 is realized by, for example, releasing all of the engagement devices of the automatic transmission 22. The driven gear 26 is a rotating member that constitutes a part of the power transmission device 16 and rotates together with the drive wheels 14, and is fixed in a non-rotatable manner by a parking lock mechanism 50 provided in the vehicle 10. Therefore, in the parking state of the power transmission device 16, the output gear 24 is fixed in a non-rotatable manner. The parking state of the power transmission device 16 is used in a similar meaning as a parking position of the automatic transmission 22.

The R operating position is a backward-running operating position to select an R state of the power transmission device 16 to allow the vehicle 10 to run backward. The N operating position is a neutral operating position to select an N state of the power transmission device 16 at which the power transmission device 16 is put into a neutral state. The D operating position is a forward-running operating position to select a D state of the power transmission device 16 to allow the vehicle 10 to run forward by executing automatic shifting control of the automatic transmission 22.

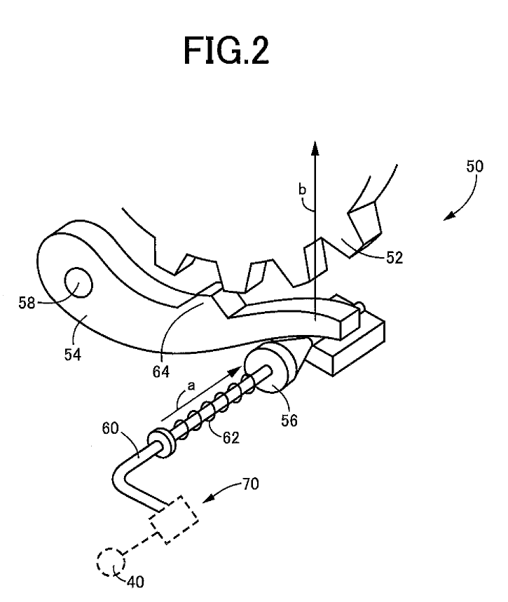

FIG. 2 is a view showing an example of the parking lock mechanism 50. In FIG. 1 and FIG. 2, the parking lock mechanism 50 is mechanically connected to the shift lever 40 via a connecting member 70 such as a link and a cable. The parking lock mechanism 50 includes a parking gear 52, a parking pawl 54, a cam 56, a support shaft 58, a parking rod 60, and a spring 62.

The parking gear 52 is a member provided so as to rotate integrally with the driven gear 26. The parking pawl 54 is a member having a pawl portion 64 that meshes with gear teeth of the parking gear 52, so that the parking pawl 54 can mesh with the parking gear 52. The cam 56 is tapered such that a diameter of the cam 56 becomes smaller toward the parking pawl 54 side, and is moved to the parking pawl 54 side to mesh the parking pawl 54 with the parking gear 52. The support shaft 58 is a member supporting the parking pawl 54 rotatably. The parking rod 60 is a member supporting the cam 56 at one end portion on the parking pawl 54 side. The parking rod 60 is mechanically connected to the shift lever 40 via the connecting member 70 at the other end portion opposite to the parking pawl 54 side, and is moved toward the one end portion side along with an operation of the shift lever 40 to the P operating position. The direction toward the one end portion side is a direction shown by an arrow a in FIG. 2. The spring 62 is a spring mechanism that biases the cam 56 to the parking pawl 54 side along with movement of the parking rod 60 toward the one end portion side.

In response to biasing of the cam 56 toward the parking pawl 54 side or movement of the cam 56 toward the opposite side of the parking pawl 54, the parking pawl 54 is rotated pivotally around a central axis of the support shaft 58. By being rotated around the central axis of the support shaft 58, the parking pawl 54 is selectively switched between a meshing position at which the pawl portion 64 meshes with the gear teeth of the parking gear 52 and a non-meshing position at which meshing between the pawl portion 64 and the gear teeth of the parking gear 52 is released. The parking lock mechanism 50 fixes the driven gear 26 in a non-rotatable manner in response to switching of the parking pawl 54 to the meshing position. The parking lock mechanism 50 establishes the parking state of the power transmission device 16 by meshing the parking pawl 54 with the parking gear 52.

When the shift lever 40 is operated to the P operating position by a driver, the parking rod 60 is moved in the direction of the arrow a, and the cam 56 is biased toward the parking pawl 54 side by the spring 62. When the cam 56 is biased to the parking pawl 54 side, the parking pawl 54 is moved in a direction of the arrow b. When the parking pawl 54 is moved to a position where the parking pawl 54 meshes with the parking gear 52, the drive wheels 14 that rotate in conjunction with the parking gear 52 are fixed in a non-rotatable manner, and the shift position of the power transmission device 16 is switched to the parking state.

Referring to FIG. 1 again, the vehicle 10 includes a wheel braking device 72 that applies a brake torque to wheels obtained by wheel brakes. In response to a brake operation with, for example, a brake pedal by a driver, the wheel braking device 72 supplies a brake hydraulic pressure to wheel cylinders provided in the wheel brakes. In this wheel braking device 72, under normal conditions, a master cylinder hydraulic pressure Pmc having a magnitude corresponding to a pedal depressing force on a brake pedal and generated from the brake master cylinder, is directly supplied as a brake hydraulic pressure to the wheel cylinders. On the other hand, in the wheel braking device 72, for example, at the time of ABS control or vehicle speed control, etc., for generating a brake torque, a brake hydraulic pressure necessary for each control is supplied to the wheel cylinders regardless of the pedal depressing force. The above-described wheels include the drive wheels 14 and driven wheels not illustrated.

The vehicle 10 further includes an electronic control device 90 as a controller including a control device of the vehicle 10 relating to, for example, control of a vehicle speed V, etc. The electronic control device 90 includes a so-called microcomputer including, for example, a CPU, a RAM, a ROM, and an I/O interface, etc., and the CPU executes various controls of the vehicle 10 by performing signal processing according to a program stored in advance in the ROM while utilizing a temporary storage function of the RAM. For example, the electronic control device 90 is configured to execute output control of the engine 12 and shifting control of the automatic transmission 22, etc., and the electronic control device 90 may be configured in separated devices for each controls such as the engine output control and the shifting control as appropriate.

To the electronic control device 90, various signals (for example, an engine rotation speed Ne, an input rotation speed Ni as a rotation speed of an input rotation member of the automatic transmission 22, an output rotation speed No as a rotation speed of the output gear 24 corresponding to a vehicle speed V, an accelerator opening degree θacc as an operating amount of an accelerator pedal, an operating position POSsh of the shift lever 40, and a master cylinder hydraulic pressure Pmc generated from the brake master cylinder, etc.,) are supplied based on detection values detected by various sensors (for example, an engine rotation speed sensor 80, an input rotation speed sensor 82, an output rotation speed sensor 84, an accelerator opening sensor 86, a shift position sensor 88, a master cylinder pressure sensor 89, etc.,) provided in the vehicle 10. From the electronic control device 90, various signals (for example, an engine control command signal Se, a hydraulic control command signal Sat, and a brake control command signal Sb, etc.,) are supplied to the respective devices (for example, the engine 12, the hydraulic control circuit 38, the wheel braking device 72, etc.,) provided in the vehicle 10.

To realize control functions for various controls in the vehicle 10, the electronic control device 90 includes an engine control means, that is, an engine control portion 92, and a shifting control means, that is, a shifting control portion 94.

The engine control portion 92 controls the engine 12 so as to obtain a requested engine torque Te. For example, the engine control portion 92 calculates a requested drive torque Tdem by applying, for example, an accelerator opening θacc and a vehicle speed V to a drive force map which is a relationship obtained experimentally or in design and stored in advance, that is, a predetermined relationship. The engine control portion 92 calculates an engine control command signal Se to obtain an engine torque Te which realizes the requested drive torque Tdem by taking into account an auxiliary machine load and a gear ratio γ of the automatic transmission 22, etc., and outputs the engine control command signal Se to a throttle actuator, the fuel injection device, and an ignition device, etc. The vehicle speed V is used in the similar manner as an output rotation speed No, etc.

The shifting control portion 94 executes shifting control of the automatic transmission 22. For example, the shifting control portion 94 determines whether it is necessary to switch the gear position of the automatic transmission 22 by using, for example, a shifting map which is a predetermined relationship, and when shifting determination is made that it is necessary to switch the gear position, the shifting control portion 94 outputs a hydraulic control command signal Sat for switching of actuation states of the engagement devices to the hydraulic control circuit 38 so as to switch the gear position of the automatic transmission 22 as appropriate.

Here, the parking lock mechanism 50 is mechanically connected to the shift lever 40 via the connecting member 70, so that an operation of the shift lever 40 performed by a driver is directly reflected in actuation of the parking lock mechanism 50. Therefore, when the shift lever 40 is operated to the P operating position by the driver even while running of the vehicle 10, the parking lock mechanism 50 is actuated so as to mesh the parking pawl 54 with the parking gear 52. At this time, when the vehicle speed V is higher than an engage vehicle speed, the parking pawl 54 is repelled by the parking gear 52. The parking lock mechanism 50 includes the spring 62, so that the parking pawl 54 repeatedly attempts to mesh with the parking gear 52 due to the biasing force of the spring 62. The engage vehicle speed is, for example, an upper limit vehicle speed at which the parking pawl 54 can mesh with the parking gear 52.

The parking pawl 54 is subjected to a load caused by collision with the parking gear 52. In the present embodiment, reduction of the burden on the parking lock mechanism 50 and peripheral components caused by such a load is proposed.

Behavior of the parking pawl 54 is determined by a gear teeth passing frequency of the parking pawl 54 and an amount of biasing force of the spring 62. The gear teeth passing frequency is a frequency, i.e. amount per unit time, of the gear teeth of the parking gear 52 passing the pawl portion 64, and is determined by the number of teeth and the rotation speed of the parking gear 52. The behavior of the parking pawl 54 is a movement in which repelling of the parking pawl 54 by the parking gear 52 and attempting to mesh with the parking gear 52 are repeated.

Regarding the behavior of the parking pawl 54, there are a vehicle speed range in which meshing of the parking pawl 54 with the parking gear 52 is shallow, and a vehicle speed range in which meshing is deep. In the behavior of the parking pawl 54, repelling by the parking gear 52 becomes faster i.e., more frequently in response to an increase in rotation speed of the parking gear 52 i.e., as the vehicle speed V becomes higher. Therefore, meshing of the parking pawl 54 becomes shallower in a comparatively high vehicle speed range than in a comparatively low vehicle speed range. On the other hand, a load to be applied to the parking pawl 54 becomes smaller in a case of relatively shallow meshing than in a case of relatively deep meshing. Therefore, a load to be applied to the parking pawl 54 becomes smaller in the comparatively high vehicle speed range than in the comparatively low vehicle speed range. The energy of rotation of the parking gear 52 becomes smaller in response to a decrease in rotation speed of the parking gear 52 i.e., as the vehicle speed V becomes lower. Therefore, the load to be applied to the parking pawl 54 becomes smaller although meshing of the parking pawl 54 becomes deeper in a lower-side vehicle speed range in the comparatively low vehicle speed range, as compared with a higher-side vehicle speed range in the comparatively low vehicle speed range. That is, magnitude of the load to be applied to the parking pawl 54 due to collision with the parking gear 52 differs depending on the vehicle speed V. Therefore, there are a vehicle speed range in which the burden on the parking lock mechanism 50 and the peripheral components is larger and a vehicle speed range in which the burden is smaller. In such a circumstance, the electronic control device 90 attempts to avoid the vehicle speed range in which the burden on the parking lock mechanism 50 and the peripheral components is larger when the shift lever 40 is operated to the P operating position by a driver while running of the vehicle 10.

The electronic control device 90 further includes a status determination means, that is, a status determination portion 96 and a vehicle speed control means, that is, a vehicle speed control portion 98, for executing controls to avoid the above-described vehicle speed range in which the burden on the parking lock mechanism 50 and the peripheral components is larger.

The status determination portion 96 determines, while running of the vehicle 10, whether the shift lever 40 has been operated to the P operating position and the vehicle speed V is in a predetermined vehicle speed range Vlim. The predetermined vehicle speed range Vlim is, for example, a vehicle speed range determined in advance of a vehicle speed V at which the load to be applied to the parking pawl 54 due to collision with the parking gear 52 becomes larger. In detail, the predetermined vehicle speed range Vlim is a vehicle speed range not less than an upper limit vehicle speed A in a low vehicle speed range in which, due to a low rotation speed of the parking gear 52, energy of rotation of the parking gear 52 decreases and the load to be applied to the parking pawl 54 becomes smaller, and not more than a lower limit vehicle speed B in a high vehicle speed range in which, due to a high rotation speed of the parking gear 52, meshing of the parking pawl 54 with the parking gear 52 becomes shallower and the load to be applied to the parking pawl 54 becomes smaller. The upper limit vehicle speed A is also defined as the highest vehicle speed in the low vehicle speed range in which, due to a low rotation speed of the parking gear 52, energy of rotation of the parking gear 52 decreases and the load to be applied to the parking pawl 54 becomes smaller. The lower limit vehicle speed B is also defined as the lowest vehicle speed in the high vehicle speed range in which, due to a high rotation speed of the parking gear 52, meshing of the parking pawl 54 with the parking gear 52 becomes shallower and the load to be applied to the parking pawl 54 becomes smaller.

The status determination portion 96 determines whether the shift lever 40 has been operated to the P operating position based on whether the operating position POSsh of the shift lever 40 is at the P operating position. The status determination portion 96 determines whether the vehicle speed V is in the predetermined vehicle speed range Vlim based on whether the vehicle speed V is not less than the upper limit vehicle speed A and not more than the lower limit vehicle speed B. That is, the status determination portion 96 determines whether the operating position POSsh of the shift lever 40 is the P operating position, and the vehicle speed V is equally to or larger than the upper limit vehicle speed A and equal to or lower than the lower limit vehicle speed B while running of the vehicle 10. The upper limit vehicle speed A is higher than the engage vehicle speed.

When the status determination portion 96 determines that the shift lever 40 has been operated to the P operating position and the vehicle speed V is in the predetermined vehicle speed range Vlim while running of the vehicle 10, the vehicle speed control portion 98 controls the vehicle speed V so as to make the vehicle speed V come out of the predetermined vehicle speed range Vlim. Control of the vehicle speed V so as to make the vehicle speed V come out of the predetermined vehicle speed range Vlim is control to quickly avoid the predetermined vehicle speed range Vlim as compared with, for example, a spontaneous state where the vehicle speed V is not controlled, and is control to prevent the vehicle speed V from staying in the predetermined vehicle speed range Vlim.

In detail, the vehicle speed control portion 98 controls the vehicle speed V so as to make the vehicle speed V come out of the predetermined vehicle speed range Vlim by performing control to promote deceleration of the vehicle 10. The control to promote deceleration of the vehicle 10 is, for example, a control to decelerate the vehicle 10 in a state where the vehicle speed V is not changed, or for example, a control to more quickly decelerate the vehicle 10 than a spontaneous decrease in a state where the vehicle speed V spontaneously decreases. The control to promote deceleration of the vehicle 10 is, for example, a control to apply a brake torque to the vehicle 10 without depending on a driver's operation.

The vehicle speed control portion 98 applies a brake torque to the vehicle 10 by using an engine brake from the engine 12. When the shift lever 40 is at the P operating position, the automatic transmission 22 is in a neutral state. When performing the control to promote deceleration of the vehicle 10, the vehicle speed control portion 98 applies a brake torque to the vehicle 10 from the engine brake by engaging the engagement device(s) relating to establishing the first-speed gear position in a slip-engaged manner in the automatic transmission 22, rather than putting the automatic transmission 22 into a neutral state.

Alternatively, the vehicle speed control portion 98 applies a brake torque to the vehicle 10 by using wheel brake of the wheel braking device 72 in place of or in addition to the engine brake.

The vehicle speed control portion 98 performs control to promote deceleration of the vehicle 10 so as to decrease the vehicle speed V in a predetermined gradient, for example. This predetermined gradient is, for example, a decreasing rate of the vehicle speed V determined in advance so as to suppress discomfort sensed by a driver due to a decrease in vehicle speed V.

Alternatively, the vehicle speed control portion 98 may perform control to promote deceleration of the vehicle 10 by managing, for example, the deceleration or the brake torque of the vehicle 10 instead of controlling the vehicle speed V directly.

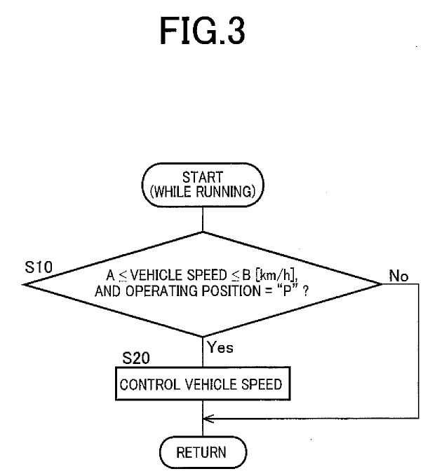

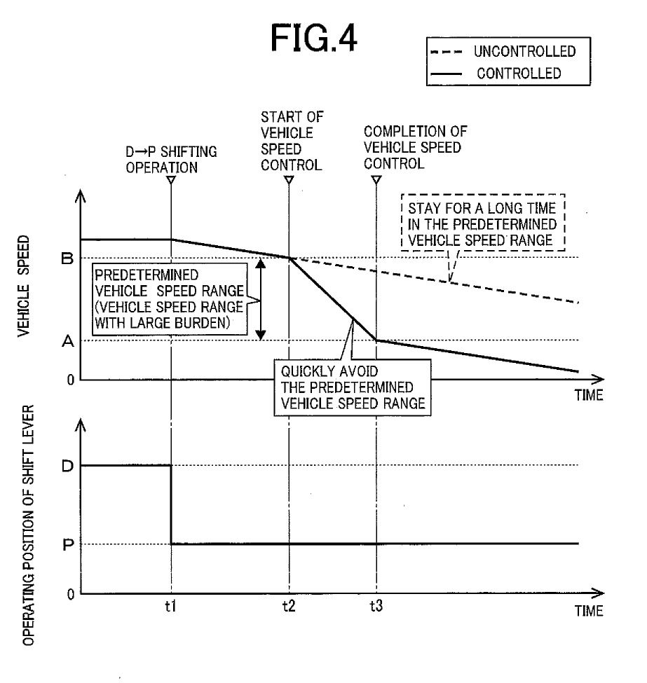

FIG. 3 shows a flowchart describing an essential portion of a control operation of the electronic control device 90, that is, a control operation to reduce the burden on the parking lock mechanism 50 when the shift lever 40 is operated to the P operating position while running of the vehicle 10, and the control operation is repeatedly executed while running of the vehicle 10. FIG. 4 is a diagram showing an example of a time chart when the control operation shown in the flowchart of FIG. 3 is executed.

In FIG. 3, first, in Step (hereinafter, “Step” is omitted) S10 corresponding to a function of the status determination portion 96, whether the operating position POSsh of the shift lever 40 is at the P operating position and the vehicle speed V is equal to or larger than the upper limit vehicle speed A and equal to or lower than the lower limit vehicle speed B is determined. When the result of the determination in S10 is negative, this routine is completed. When the result of the determination in S10 is positive, in S20 corresponding to a function of the vehicle speed control portion 98, the vehicle speed V is controlled so as to come out of the predetermined vehicle speed range Vlim being a vehicle speed range equal to or larger than the upper limit vehicle speed A and equal to or lower than the lower limit vehicle speed B. When the result of the determination in S10 described above is negative in a state where the vehicle speed V is already under control, the control of the vehicle speed V is completed.

FIG. 4 shows an example of an embodiment when the shift lever 40 is operated to the P operating position while the vehicle 10 is running at a vehicle speed V over the lower limit vehicle speed B. In FIG. 4, at the time point t1, the shift lever 40 is operated from the D operating position to the P operating position while running of the vehicle 10. At this time point, the vehicle speed V is not in the predetermined vehicle speed range Vlim, so that the vehicle speed control to promote deceleration of the vehicle 10 is not executed. In response to an operation of the shift lever 40 to the P operating position, the automatic transmission 22 is put into a neutral state, and the vehicle speed V is spontaneously decreased (refer to the time point t1 to the time point t2). According to this decrease in vehicle speed V, when the vehicle speed V decreases to the lower limit vehicle speed B and enters the predetermined vehicle speed range Vlim, the vehicle speed control is started (refer to the time point t2). As shown by the dashed line, when the vehicle speed control is not executed, the vehicle speed V is made to stay for a longer time in the predetermined vehicle speed range Vlim. On the other hand, when the vehicle speed control is executed as shown by the solid line, the predetermined vehicle speed range Vlim can be quickly avoided (refer to the time point t2 to the time point t3). Accordingly, the burden on the parking lock mechanism 50 and the peripheral components can be reduced. When the vehicle speed V decreases to be lower than the upper limit vehicle speed A and comes out of the predetermined vehicle speed range Vlim, the vehicle speed control is completed (refer to the time point t3). Thereafter, the vehicle speed V is spontaneously decreased (refer to the section after the time point t3).

As described above, according to the present embodiment, when the shift lever 40 is operated to the P operating position and the vehicle speed V is in the predetermined vehicle speed range Vlim while running of the vehicle 10, the vehicle speed V is controlled so as to come out of the predetermined vehicle speed range Vlim, so that the period of time during which the vehicle speed V stays in the vehicle speed range Vlim where the load to be applied to the parking pawl 54 is increased is shortened. Accordingly, the number of collisions of the parking pawl 54 with the parking gear 52 which apply a significant load to the parking pawl 54 is reduced. Therefore, when the shift lever 40 is operated to the P operating position while running of the vehicle 10, the burden on the parking lock mechanism 50 and the peripheral components can be reduced.

According to the present embodiment, the predetermined vehicle speed range Vlim is a vehicle speed range equal to or larger than the upper limit vehicle speed A in the low vehicle speed range in which, due to a low rotation speed of the parking gear 52, the load to be applied to the parking pawl 54 becomes smaller, and equal to or lower than the lower limit vehicle speed B in the high vehicle speed range in which, due to a high rotation speed of the parking gear 52, the load to be applied to the parking pawl 54 becomes smaller, so that a period of time during which the vehicle speed V stays in the vehicle speed range where the load to be applied to the parking pawl 54 is increased is shortened by controlling the vehicle speed V so as to make the vehicle speed come out of the predetermined vehicle speed range Vlim.

According to the present embodiment, the vehicle speed V is controlled so as to come out of the predetermined vehicle speed range Vlim by performing the control to promote deceleration of the vehicle 10, so that a period of time during which the vehicle speed V stays in the vehicle speed range in which the burden on the parking pawl 54 increases is appropriately shortened by quick deceleration of the vehicle 10.

According to the present embodiment, the control to promote deceleration of the vehicle 10 is a control to apply a brake torque to the vehicle 10 without depending on a driver's operation, so that the vehicle 10 is quickly decelerated by the control to promote deceleration of the vehicle 10.

An embodiment of the present invention is described in detail above, however, the present invention is also applied in other embodiments.

For example, in the embodiment described above, as a brake torque to be applied to the vehicle 10 in the control to promote deceleration of the vehicle 10, a brake torque generated by the engine brake and a brake torque generated by the wheel brake are shown by way of example, however, the present invention is not limited to these embodiments. For example, when the automatic transmission included in the power transmission device 16 is a publicly-known electrically controlled continuously variable transmission, a brake torque generated by an engine brake can be controlled while the engine rotation speed can be changed by controlling a motor. At least in a vehicle including a motor, by using a regenerative brake generated by the motor, a brake torque can be applied to the vehicle. In a vehicle configured such that a parking brake is not mechanically connected to a parking member to be operated by a driver and the parking brake is actuated by an actuator in response to an operation of the parking member by a driver, a brake torque can be applied to the vehicle by using the parking brake.

In the embodiment described above, performing the control to promote deceleration of the vehicle 10 is shown as an example in which the vehicle speed V is controlled so as to come out of the predetermined vehicle speed range Vlim, however, the present invention is not limited to this embodiment. For example, the vehicle speed control portion 98 may control to increase the vehicle speed V so as to make the vehicle speed V come out of the predetermined vehicle speed range Vlim. In detail, when in a spontaneous state where the vehicle speed V is not controlled, the vehicle speed V is maintained at the lower limit vehicle speed B or a vehicle speed slightly lower than the lower limit vehicle speed B, the vehicle speed control portion 98 controls the vehicle speed V so as to make the vehicle speed V come out of the predetermined vehicle speed range Vlim by performing control to increase the vehicle speed V slightly higher than the lower limit vehicle speed B.

In the embodiment described above, power of the engine 12 is transmitted to the automatic transmission 22 through the torque converter 20, however, the configuration is not limited to this configuration. For example, in place of the torque converter 20, another fluid type transmission device such as a fluid coupling having no torque amplifying effect may be used. Alternatively, a frictional clutch or the like may be provided in place of the fluid type transmission device. Alternatively, when the automatic transmission included in the power transmission device 16 is a publicly-known DCT (Dual Clutch Transmission), etc., the fluid type transmission device does not necessarily have to be provided.

The above-described embodiments are just embodiments, and the present invention can be carried out in embodiments variously changed or improved based on knowledge of persons skilled in the art.

### REFERENCE SIGNS LIST

10: Vehicle
12: Engine (Power source)
14: Drive wheels
16: Power transmission device
26: Driven gear (Rotating member)
40: Shift lever (Operating member)
50: Parking lock mechanism
52: Parking gear
54: Parking pawl
56: Cam
60: Parking rod
62: Spring (Spring mechanism)
70: Connecting member
90: Electronic control device (Control device)
98: Vehicle speed control portion

1. A control device of a vehicle comprising: a power transmission device provided in a power transmission path between a power source and a drive wheel; a rotating member constituting a part of the power transmission device and rotating together with the drive wheel; a parking lock mechanism including a parking gear provided so as to rotate integrally with the rotating member and a parking pawl configured to mesh with the parking gear, and being configured to form a parking state of the power transmission device in which the rotating member is fixed in an non-rotatable manner by meshing the parking pawl with the parking gear; and an operating member to be operated by a driver to any of a plurality of operating positions including a parking operating position to select a parking position of the power transmission device, the parking lock mechanism further including a cam tapered so as to become smaller in diameter toward the parking pawl side and configured to mesh the parking pawl with the parking gear by being moved to the parking pawl side, a parking rod supporting the cam at one end portion on the parking pawl side and mechanically connected to the operating member via a connecting member at the other end portion opposite to the parking pawl side, and configured to be moved toward the one end portion side along with an operation of the operating member to the parking operating position, and a spring mechanism configured to bias the cam to the parking pawl side along with movement of the parking rod toward the one end portion side, and configured in that:
the control device includes
a vehicle speed control portion to control a vehicle speed such that when the operating member is operated to the parking operating position and the vehicle speed is in a predetermined vehicle speed range determined in advance of a vehicle speed at which a load to be applied to the parking pawl due to collision with the parking gear increases while running of the vehicle, the vehicle speed comes out of the predetermined vehicle speed range.

2. The control device of a vehicle according to claim 1, wherein the predetermined vehicle speed range is a vehicle speed range equal to or larger than an upper limit vehicle speed in a low vehicle speed range in which the load becomes relatively small due to a low rotation speed of the parking gear, and equal to or lower than a lower limit vehicle speed in a high vehicle speed range in which, due to a high rotation speed of the parking gear, meshing of the parking pawl with the parking gear becomes relatively shallow and the load becomes relatively small.

3. The control device of a vehicle according to claim 1, wherein the vehicle speed control portion controls the vehicle speed so as to make the vehicle speed come out of the predetermined vehicle speed range by performing a control to promote deceleration of the vehicle.

4. The control device of a vehicle according to claim 2, wherein the vehicle speed control portion controls the vehicle speed so as to make the vehicle speed come out of the predetermined vehicle speed range by performing a control to promote deceleration of the vehicle.

5. The control device of a vehicle according to claim 3, wherein the control to promote deceleration of the vehicle is a control to apply a brake torque to the vehicle without depending on an operation by the driver.

6. The control device of a vehicle according to claim 4, wherein the control to promote deceleration of the vehicle is a control to apply a brake torque to the vehicle without depending on an operation by the driver.
